(19) United States
(12) Patent Application Publication
(10) Pub. No.: US 2014/0059878 A1
(43) Pub. Date: Mar. 6, 2014

(54) HEAT TREATMENT OF A LASER COATING

(71) Applicants: Mattieu Bilaine, Paris (FR); Vincent Rachet, Montrouge (FR)

(72) Inventors: Mattieu Bilaine, Paris (FR); Vincent Rachet, Montrouge (FR)

(73) Assignee: Saint-Gobain Glass France, Courbevoie (FR)

(21) Appl. No.: 14/001,178

(22) PCT Filed: Feb. 21, 2012
(86) PCT No.: PCT/FR2012/050365

§ 371 Date: Nov. 1, 2013

(30) Foreign Application Priority Data
Feb. 25, 2011 (FR) 1151576

(51) Int. Cl. F26B 3/30

(52) U.S. Cl. CPC F26B 3/30
USPC 34/266; 34/245; 34/275

(57) ABSTRACT

The invention relates to a process for heating an organic coating applied to a number of substrates, especially a mirror, laser radiation being applied to the organic coating while the substrates run past without stopping. This process especially allows paints or inks to be dried or baked with little heat transfer to the substrate.

The invention relates to the field of paint on substrates and describes a laser drying and/or baking process especially suitable for paints or inks comprising an organic or water-based solvent.

Various processes for applying liquid or powder paint or ink to substrates that are flat or slightly inclined to the horizontal (sin(angle/vertical) >0.95) are available at the present time, especially roller coating processes, curtain coating processes and spray or electrostatic spray coating processes.

The paints are then dried and/or baked in an oven or lehr. Three main techniques for carrying out this drying and/or baking operation are available at the present time: air drying, oven drying/baking, and UV curing. The run speed of the paint-coated substrates through the drying or baking oven or lehr may range from a few m/min for glass substrates to 1 km/min in the case of rotary presses for example.

The air drying technique is very slow (waiting times of several hours are required) and is limited to the use of quick-drying (without baking) paints.

The oven drying/baking technique is the most widely used industrially at the present time. Based on ovens using near/mid infrared radiation, these installations require ovens that are a few tens of meters in length depending on the run speed of the substrates and the required baking time.

Based on a technology using a very small amount of solvent, the baking technique called UV curing is a purely photochemical process in which the paint is irradiated with UV radiation in order to cure it. This technique enables a higher throughput than is possible with oven drying/baking but causes environmental problems, especially because it generates large amounts of ozone, acrylates and free-radicals in the production zone.

The present invention proposes combining the power of an intense beam of laser radiation (which of course does not exclude the possibility of there being several beams of this type) with conventional paints or inks intended for an oven process. The invention is particularly suitable for heat treatment of coated substrates having large areas, especially areas ranging from 1 to 25 m².

The invention relates to a process for heating an organic coating applied to a number of substrates, laser radiation being applied to the organic coating while the substrates run past without stopping.

The coating is organic insofar as it comprises at least one organic compound before the laser treatment according to the invention. For example, the coat of paint commonly used to protect the backs of mirrors is an organic coating because it contains an organic solvent or an organic resin. The coating may comprise an organic pigment. After treatment by the process according to the invention, the coating generally still comprises an organic compound.

The invention is particularly suitable for drying or baking coats of paint applied to glass substrates such as to the backs of mirrors, especially, in the latter case, with a view to protecting the silver film from corrosion.

The laser treatment according to the invention is furthermore noteworthy in that, in contrast to annealing or tempering treatments, the substrate is not heated to a significant degree. Thus, it is not necessary for the coated substrate to undergo slow and controlled cooling before it is cut and stored. This process also makes it possible to integrate a heating device on existing continuous production lines, especially a line for producing mirrors, which mirror production line may comprise a silver-film preheating zone in order to remove trace moisture.

The substrate may especially comprise or be a glass sheet, a glass-ceramic sheet or a sheet made of an organic polymer. For a mirror application, it is preferably transparent. It may be colorless (it is then a clear glass or extra-clear glass sheet) or have a tint, for example a blue, green, gray or bronze tint. The glass is preferably soda-lime-silica glass, but may also be borosilicate or alumino-borosilicate glass. The preferred organic polymers are polycarbonate or polymethyl methacrylate or even polyethylene terephthalate (PET). The substrate may have at least one dimension that is larger than or equal to 1 m, even 2 m and even 3 m in size. The substrate is generally from 0.5 mm to 20 mm in thickness, for a mirror application it is especially 0.7 to 9 mm in thickness, especially 2 to 8 mm in thickness, and even 4 to 6 mm in thickness. The substrate may be flat or curved. It may be stiff or flexible.

If it is made of glass the substrate will generally be made of float glass, i.e. glass likely to have been obtained by a process consisting in pouring molten glass onto a bath of molten tin (the “float” bath). In this case, the coating to be treated may either be placed on the “tin” side or on the “atmosphere” side of the substrate. The expressions “atmosphere” and “tin” sides are understood to mean those sides of the substrate which made contact with the atmosphere above the float bath and with the molten tin, respectively. The tin side contains a small amount of superficial tin having diffused into the structure of the glass. The glass substrate may also be obtained by rolling between two rollers, this technique in particular allowing patterns to be imprinted in the surface of the glass.

According to the invention the substrate may especially be a glass substrate coated with an organic-solvent-comprising or water-diluted or even water-soluble paint or ink (comprising at least one pigment especially taking the form of nanoparticles or comprising at least one organic dye). The invention is particularly, but not exclusively, suitable for alkyd, acrylic and polyurethane inks and paints. The temperature ranges achievable using the technique according to the invention are particularly, but not exclusively, suitable for technologies based on urea/formaldehyde, epoxy or isocyanate curing mechanisms.

The heat treatment is carried out using at least one beam of laser radiation. The power per unit area of the laser radiation in the coating is preferably 20 kW/cm² or more and even 30 kW/cm² or more. This very high energy density allows the desired temperature to be reached in the coating very rapidly (in general in a time of 1 second or less) and therefore the treatment length to be correspondingly limited, the generated heat furthermore having no time to diffuse into the substrate.

By virtue of the very high heat exchange coefficient associated with the process according to the invention, even that part of the (especially glass) substrate located 0.5 mm from the coating generally does not experience temperatures above 100° C. Therefore, the substrate generally does not experience a temperature above 100° C. at a depth of 0.5 mm from the substrate/coating interface.

By virtue of the very high uniformity of the power of the laser line associated with the process according to the invention, said power varying by no more than 5% along the line, even varying by no more than 1% along the line, the coating experiences a uniform temperature that allows the paints or inks to be dried or baked, yet without generating defects.

The process according to the invention is a continuous process: a relative movement is created between the coated substrate and the laser heating means in order to allow the desired area, generally the entire surface, to be treated.

The laser radiation preferably has a wavelength between 266 and 11000 nm, and especially between 530 and 1200 nm. This is because in this wavelength range absorption in the coating (paint or ink) is maximal. Thus, the radiation is absorbed specifically by the coating and little by the substrate, thereby allowing the coating to be rapidly heated without heating the substrate.

Preferably, absorption by the coating (ink or paint) before the laser heat treatment according to the invention, at the wavelength of the laser radiation, is 20% or more, and especially 30% (absorption=100%−transmission−reflection, the transmission and the reflection being measured on the coating/substrate assembly, for example using a device such as a Lambda 900 spectrometer) for a characteristic coating thickness of 10 μm for normal transmission (perpendicular to the coated substrate). In contrast, the glass, especially if it is clear or extra-clear glass, absorbs very little in this wavelength range and hence the radiation mainly heats the coating. Absorption is defined as being equal to 100% minus transmission through and reflection from the coating.

Laser diodes, for example emitting at a wavelength of about 808 nm, 880 nm, 940 nm, or even 980 nm or 1032 nm, are preferably used. Very high powers can be obtained using systems of diodes, these systems allowing powers per unit area higher than 20 kW/cm² and even higher than 30 kW/cm² to be obtained in the coating to be treated.

To increase the simplicity of the implementation of the process, the lasers employed in the context of the invention may be fibered, i.e. the laser radiation (produced using any gain medium: gas, liquid, solid) is injected into an optical fiber then delivered near the surface to be treated via a focusing lens. Notably, the laser may also be a fiber laser in the sense that the amplification medium (i.e. the gain medium) is itself an optical fiber, generally one doped with rare-earth ions. The laser radiation may be obtained from at least one laser beam forming a line (called the “laser line” in the following text) that simultaneously irradiates the entire width of the substrate coated with the coating to be heated. This embodiment avoids the need to use expensive movement systems that are generally bulky and difficult to maintain. The line-shaped laser beam may especially be obtained using systems of high-power laser diodes associated with focusing optics. The line is preferably between 0.01 and 1 mm in thickness. The length of the line is tailored to the width of the substrate to be treated; it is typically between 5 mm and 4 m in length. The intensity of the line (in its width) may especially have a Gaussian or a top-hat profile.

Generally, the laser radiation is applied in a line lying substantially transverse the run direction of the substrates.

The laser line simultaneously irradiating all or part of the width of the substrates may be composed of a single line (then irradiating the entire width of the substrate), or of a number of optionally separate lines. When a number of lines are used it is preferable for them to be placed so that the entire area of the coating to be heated is treated. The laser line may be placed obliquely to the run direction of the substrate, but it is preferably placed perpendicularly to the run direction of the substrate. In the case of a number of laser lines, the latter may treat the substrate simultaneously or in a way staggered in time. In practice various laser beams are either physically focused on the same location in order to obtain a simultaneous treatment of the substrate, or they are staggered in space in order to treat one after the other a given width of the substrate as it runs past. The most important thing is for the entire area to be treated, to be treated.

In order to continuously treat the entire area of the coating, a relative movement is created between, on the one hand, the substrate coated with the coating, and on the other hand, the laser line. The substrate coated with the coating to be laser treated may thus be made to move, especially run in translation, opposite, generally under but optionally over, the stationary laser line. Preferably, the difference between the respective velocities of the substrate and the laser is greater than or equal to 1 meter per minute, or 4 and even 6, 8, 10 or 20 meters per minute in order to ensure a high treatment speed. Generally, the run speed of the substrates is from 1 to 20 meters per minute.

The substrate may be moved in translation using any mechanical conveying means, for example using conveyor belts, rollers, or trays. The conveying system allows the speed of the movement to be controlled and adjusted. If the substrate is made of a flexible organic material, generally a polymer such as PVC or PTFE, it may be moved using a film transport system comprising a succession of rollers.

The laser may also be moved so as to adjust its distance from the substrate, which may in particular be useful when the substrate is curved, but not only in such a case. Indeed, it is preferable for the laser beam to be focused onto the coating to be treated so that the latter is located a distance of 1 mm or less from the focal plane. Ideally, the coating coincides with the focal plane. If the system for moving the substrate or moving the laser is not sufficiently precise as regards the distance between the substrate and the focal plane, it is preferable to be able to adjust the distance between the laser and the substrate. This adjustment may be automatic, and especially controlled using a distance measured upstream of the treatment.

All relative positions of the substrate and the laser are possible provided that the surface of the substrate can be suitably irradiated. More generally, the substrate is placed horizontally, but it may also be placed vertically, or at any possible inclination. When the substrate is placed horizontally, the laser is generally placed so as to irradiate the top side of the substrate.

The line-shaped laser may be integrated into a line for manufacturing lacquered glass or mirrors, in particular solar mirrors.

In the case of a mirror application, the line-shaped laser is located in the production process after silvering steps, and it for example acts as an element for preheating the glass before the deposition of a coat of paint or just after this coating has been deposited. The coated substrate may thus be treated in line after the coating (ink or paint) to be treated has been deposited, either at the exit of the deposition installation and before optical monitoring devices, or after optical monitoring devices and before devices for stacking the substrates.

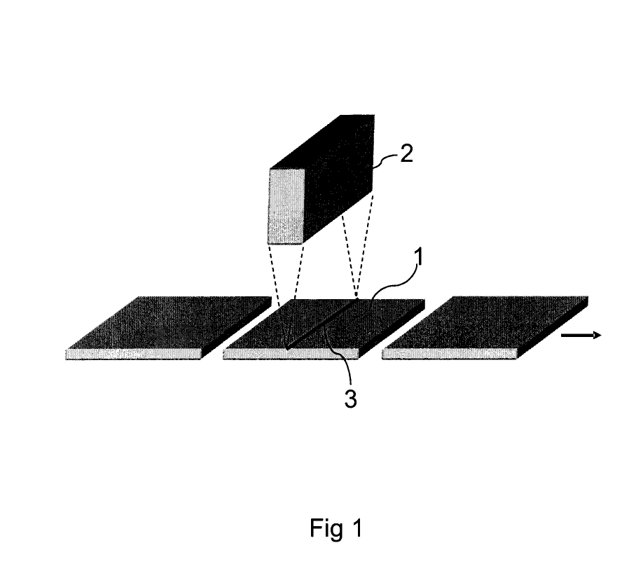

A laser line, such as for example illustrated in FIG. 1, allows a coating (ink or paint) having a thickness between in general 1 μm and 200 μm to be heated extremely rapidly before the laser treatment (i.e. the heating operation) according to the invention. The inks and paints used in oven baking are naturally very absorbent in the infrared; a laser emitting in a wavelength range typically extending from 266 nm to 11000 nm thus allows an optimal transfer of energy between the radiation source and the coat of paint.

The laser heating process according to the invention may especially be used in four principal operating modes: drying, rapid temperature increase, baking, or with powder paints:
drying mode: in this case, the laser irradiation allows an amount of energy corresponding to the latent heat of vaporization (L) of the solvent to be evaporated to be very rapidly transferred; in this case, a high flow of air ensures extraction of the solvent vapors;
rapid temperature increase: after drying, the coating (paint or lacquer or ink) retains its absorbent properties in the infrared; thus the laser treatment allows the temperature of the dry coating to be rapidly increased with a view to its subsequent baking in a baking oven; the drying itself may be carried out in a lehr or using the treatment according to the invention, the drying being followed by a laser heat treatment according to the invention;
baking: it is a question here of keeping the coating above the baking temperature for a sufficient amount of time, i.e. generally from a few seconds to a few minutes; two possible treatments are then especially possible:
   using a number of laser lines in succession to keep the temperature of the coating above the baking threshold for sufficient time;
   sweeping the surface to be treated with the laser(s);
powder paints: applying a powder paint allows a single treatment by a laser bank to be used to melt the powder and then harden it.

The laser treatment according to the invention allows mainly the coating to be heated while minimizing heating of the substrate. This allows the total energy required to treat the coating to be decreased and/or the treatment throughput to be increased.

In particular, the process according to the invention may be used to dry or bake paints for interior or solar mirrors, and also to finish the paint of a lacquered glass sheet. The process according to the invention may be advantageously used to decrease the lengths of drying or baking ovens.

In the case where the laser treatment according to the invention is used to remove a combustible organic material (a solvent for example) from the coating, sufficient dilution and convection may be ensured using a gas such as air above the coated substrate to thus limit the risk of combustion or explosion.

For the implementation of the process according to the invention, the following parameters will generally be taken into consideration:

P [W/m²]: power density of the laser radiation;

I [m]: width of the laser beam (i.e. thickness of the laser line);

L [m]: length of the laser beam or of the set of laser beams;

e: thickness of the coating before laser treatment;

ρ: density of the wet or dry coating depending on whether the coating is to be dried (solvent evaporation) or baked (no solvent evaporation), respectively;

τ: solvent content in the coating before laser treatment;

α: absorption coefficient of the coating before laser treatment;

Cp [J/kg/K]: heat capacity of the coating before laser treatment;

Lv: latent heat of vaporization of the organic material (solvent) to be removed during the laser treatment; and

V: run speed of the substrate.

Values between which these parameters may generally be located, inclusive of limits, have been collated in table 1.

TABLE 1

| | |
|---|---|
| Min | Max |

| | | | | |
|---|---|---|---|---|
| P | 1 | kW/cm² | 200 | kW/cm² |
| e | 1 | μm | 100 | μm |

| | | |
|---|---|---|
| α | 0.5 | 1 |

| | | | | |
|---|---|---|---|---|
| l | 20 | μm | 500 | μm |
| ρ | 1 | T/m³ | 2 | T/m³ |

| | | |
|---|---|---|
| τ | 0.1 | 0.5 |

| | | | | |
|---|---|---|---|---|
| Cp | 0.5 | kJ/kg/K | 1 | kJ/kg/K |
| Lv | 200 | kJ/kg | 2000 | kJ/kg (water) |
| V | 1 | m/min | 1 | km/min |

The amount of heat delivered per unit area is approximately:

Q[J/m²]=P·I/N,

and the temperature reached is approximately:

$$Δ T = \frac{P . l}{Cp . V . e . ρ} ,$$

where ΔT represents the difference between the temperature reached and room temperature.

FIG. 1 shows the process according to the invention. Substrates 1, coated with a coating to be dried or baked, are run one behind the other continuously in a direction shown by the arrow, the substrates being conveyed by a roller bed (not shown). The substrates pass under a laser source 2 that delivers a laser line 3 focused on the surface of the running substrates and across their entire width. The laser line heats the coating allowing it to be dried or baked.

### EXAMPLE 1

On a line for manufacturing mirrors, running at a speed of 5 m/min, a coat of paint deposited on the back of a mirror by way of protective coating is dried using a drying process according to the invention. Before being dried the coating is 50 μm in thickness, has a density of 2 T/m³, a heat capacity of 0.7 kJ/kg/K, and an absorbance α of 1. The solvent content (xylene: Lv=300 kJ/kg) τ is 30 wt % (i.e. 0.3 in the above formula). A power of 330 kW/m² is satisfactory. Once the paint is dry, the density of the coating is 1.3 T/m³ and each kW/m² leads to an increase in the temperature of the paint by 4 kelvin. The laser radiation essentially heats the coating, the glass being heated only by conduction from the coating and for a very short amount of time (<1 s) limiting the increase in the average temperature of the glass to less than 1 K over its total thickness.

### EXAMPLE 2

A coat of an industrial polyurethane paint comprising blocked isocyanate requiring a temperature of 180° C. to deblock and cure the coating is baked. Using the process according to the invention, a power of 40 kW/m² is satisfactory.

1. A process for heating an organic coating applied to a number of substrates, the process comprising:
applying laser radiation to the organic coating while the substrates pass the laser radiation without stopping.

2. The process of claim 1, wherein the laser radiation is applied in a line lying substantially transverse to the passing direction of the substrates.

3. The process of claim 2, wherein the thickness of the line is between 0.01 and 1 mm.

4. The process of claim 1, wherein the substrates do not experience a temperature above 100° C. at a depth of 0.5 mm from the substrate/coating interface.

5. The process of claim 1, wherein the laser radiation has a wavelength of 266 nm to 11000 nm.

6. The process of claim 1, wherein the absorption in the coating at the wavelength of the laser radiation is greater than or equal to 20%.

7. The process of claim 1, wherein the speed of the substrates passing the laser radiation is from 1 to 20 meters per minute.

8. The process of claim 1, wherein the laser radiation is focused, and the focal plane of said radiation is located a distance of 1 mm or less from the coating.

9. The process of claim 1, wherein the coating is between 1 and 200 μm in thickness before it is heated.

10. The process of claim 1, wherein the power of the laser radiation is 20 kW/cm² or more.

11. The process of claim 1, wherein the substrates comprise a glass sheet.

12. The process of claim 1, wherein the substrates are mirrors.

13. The process of claim 1, wherein the substrates are from 2 to 8 mm in thickness.

14. The process of claim 1, wherein the coating is a coat of paint.

15. The process of claim 1, wherein the paint is an alkyd, acrylic, or polyurethane paint.

16. The process of claim 1, wherein the substrates have at least one dimension that is larger than or equal to 1 m in size.

17. The process of claim 1, wherein the laser radiation is obtained from at least one laser beam forming a line that simultaneously irradiates the entire width of the substrates.

18. The process of claim 1, wherein the laser radiation has a wavelength of 530 nm to 12000 nm.

19. The process of claim 1, wherein the absorption in the coating at the wavelength of the laser radiation is greater than or equal to 30%.

20. The process of claim 1, wherein the power of the laser radiation is 30 kW/cm² or more.
